(19) United States
(12) Patent Application Publication
(10) Pub. No.: US 2024/0138624 A1
(43) Pub. Date: May 2, 2024

(54) DUAL-PURPOSE FOOD-PROCESSING APPLIANCE

(71) Applicant: Cixi Lotek Electrical Appliance Co.,Ltd., Cixi (CN)

(72) Inventor: Zili SUN, Cixi (CN)

(73) Assignee: Cixi Lotek Electrical Appliance Co.,Ltd., Cixi (CN)

(21) Appl. No.: 18/544,459

(22) Filed: Dec. 19, 2023

(30) Foreign Application Priority Data
Oct. 28, 2022 (CN) 2022228655076

(51) Int. Cl. A47J 43/06; A22C 5/00; A22C 17/00; A47J 19/02; A47J 43/046; A47J 43/07; A47J 43/08

(52) U.S. Cl. CPC A47J 43/06; A22C 5/00; A22C 17/0026; A47J 19/023; A47J 43/046; A47J 43/0722; A47J 43/085

(57) ABSTRACT

The present disclosure discloses a dual-purpose food-processing appliance, comprising a blending body, wherein the blending body is provided with an assembly space and a control unit; a power unit, wherein the power unit is assembled in the blending body; a blending cup, wherein the blending cup is mounted in the assembly space; and a replaceable blending unit. The present disclosure is reasonable in structural design and by driving the blending unit to act through the power unit, the food-processing appliance can realize not only meat mincing but also juicing functions such as juicing oranges, thereby being convenient to use and having improved practicality.

### CROSS-REFERENCE TO RELATED APPLICATIONS

The application claims priority to Chinese patent application No. 2022228655076, filed on Oct. 28, 2022, the entire contents of which are incorporated herein by reference.

### TECHNICAL FIELD

The present disclosure relates to the technical field of blenders, and in particular, to a dual-purpose food-processing appliance.

### BACKGROUND

In order to meet people's increasing demand for healthy and diverse food, various food processors for preparing flour, meat, and fruit juice have been developed in the prior art. However, these processors can realize a single function only, and users need to buy multiple types of products correspondingly so as to meet use requirements. Existing meat mincer generally have a meat mincing function only, and existing juicing appliances can be used for juicing only. Such food-processing appliances are mono-functional, resulting in reduced practicality.

### SUMMARY

The present disclosure aims to solve the technical problem by providing a dual-purpose food-processing appliance based on the current situation of the prior art, which can realize not only meat mincing but also juicing functions, thereby being convenient to use and having improved practicality.

The technical solution adopted by the present disclosure for solving the above technical problem is as follows:
a dual-purpose food-processing appliance, comprising
a blending body, wherein the blending body is provided with an assembly space and a control unit;
a power unit, wherein the power unit is assembled in the blending body, and a transmission shaft on the power unit penetrates into the assembly space;
a blending cup, wherein the blending cup is mounted in the assembly space, and a hollow shaft tube is disposed at an inner bottom of the blending cup; and
a replaceable blending unit, wherein the blending unit is placed in the blending cup and sleeved on the shaft tube, and the transmission shaft passes through the shaft tube to be connected with the blending unit.

Preferably, the blending unit is a meat mincing appliance or a juicing appliance interchangeable with the meat mincing appliance.

Preferably, the meat mincing appliance comprises a blending shaft sleeved on the shaft tube, and at least 2 blending blades distributed on the blending shaft, wherein the blending shaft is provided with an insertion shaft, and the transmission shaft is inserted into the blending shaft.

Preferably, the juicing appliance comprises a filtering portion, and a blender connected in the filtering portion, wherein a sleeve connected with the transmission shaft is connected to a bottom end of the blender, the sleeve is inserted into the shaft tube, and a plurality of convex ribs are disposed on the blender in a staggered manner respectively.

Preferably, the blender is disposed in a hemispherical structure, at least two supporting sheets extend from an outer edge of the blender, and the supporting sheets are pressed against an inner surface of the filtering portion.

Preferably, a plurality of filtering holes are disposed at the bottom of the filtering portion respectively.

Preferably, the power unit comprises a motor, a driving gear connected with the motor, and a driven gear fitting with the driving gear, wherein the driving gear and the driven gear are arranged side by side, and the driven gear is connected with the transmission shaft.

Preferably, a limiting handle is disposed on both sides of an upper edge of the filtering portion respectively for facilitating grabbing.

Preferably, the blending body is further provided with a control button electrically connected with the control unit.

Compared with the prior art, the present disclosure has the following advantages: the present disclosure is reasonable in structural design and by driving the blending unit to act through the power unit, the food-processing appliance can realize not only meat mincing but also juicing functions such as juicing oranges, thereby being convenient to use and having improved practicality.

### BRIEF DESCRIPTION OF DRAWINGS

FIG. 1 is a structural schematic diagram of an embodiment 1;

FIG. 2 is an exploded structural schematic diagram of an embodiment 2;

FIG. 3 is a structural schematic diagram of an embodiment 3;

FIG. 4 is an exploded structural schematic diagram of the embodiment 3; and

FIG. 5 is a structural schematic diagram of a filtering portion of the embodiment 3.

Reference numerals: 1. blending body; 2. power unit; 3. blending cup; 4. blending unit; 5. meat mincing appliance; 6. juicing appliance; 10. assembly space; 11. control unit; 12. control button; 20. transmission shaft; 21. motor, 22. driving gear; 23. driven gear; 30. shaft tube; 31. blending lid; 40. blending shaft; 41. blending blade; 42. filtering portion; 43. blender, 400. insertion shaft; 420. filtering hole; 421. limiting handle; 422. supporting sheet; 430. sleeve; 431. convex rib.

### DETAILED DESCRIPTION OF THE EMBODIMENTS

Multiple embodiments of the present disclosure will be disclosed in conjunction with drawings below. For the sake of clarity, many practical details will be explained together in the following description. However, it should be understood that these practical details should not be used to limit the present disclosure. That is, in some embodiments of the present disclosure, these practical details are not necessary. Furthermore, for the sake of simplifying the drawings, some known conventional structures and components are illustrated in the drawings in a simple schematic manner.

It should be noted that all directional indications such as up, down, left, right, front, rear . . . in the embodiments of the present disclosure are only used to explain the relative position relationship, motion situation, etc. between the components in a specific posture (as shown in the drawings), and if the specific posture is changed, the directional indications are changed accordingly.

Moreover, in addition to being used to represent orientation or positional relationships, some of the above terms may also be used to represent other meanings. For example, the term “on” may also be used to represent a certain attachment or connection relationship in some cases. Those of ordinary skill in the art can understand the specific meanings of these terms in the present disclosure according to specific situations.

Furthermore, the terms “mount”, “dispose”, “provide”, “connect”, and “sleeve” should be construed in a broad sense. For example, connection may be a fixed connection, a detachable connection or an integral construction; it may be a mechanical connection or electrical connection; it may be a direct connection or indirect connection through an intermediate medium; and it may be an internal communication between two appliances, elements or constituent parts. The connection mode referred to herein is prior art without any improvement and belongs to common knowledge of those skilled in the art. Those skilled in the art can understand the specific meanings of the above terms in the present disclosure according to specific situations.

In addition, descriptions involving “first”, “second”, etc. in the present disclosure are used for descriptive purposes only rather than specifically referring to a sequence or order, and are not used to limit the present disclosure. They are only intended to distinguish components or operations described with the same technical terminology, and cannot be understood as indicating or implying their relative importance or implying the quantity of technical features indicated. Therefore, defining a feature with “first” and “second” can explicitly or implicitly indicate that at least one of such feature is included. In addition, technical solutions of the embodiments may be combined with each other, but must be based on what those of ordinary skill in the art can implement. When the combination of technical solutions is contradictory or cannot be implemented, it should be considered that such combination of technical solutions neither exists nor falls within the protection scope claimed by the present disclosure.

### Embodiment

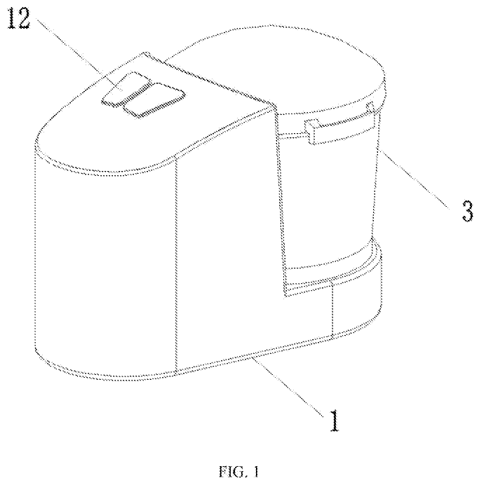

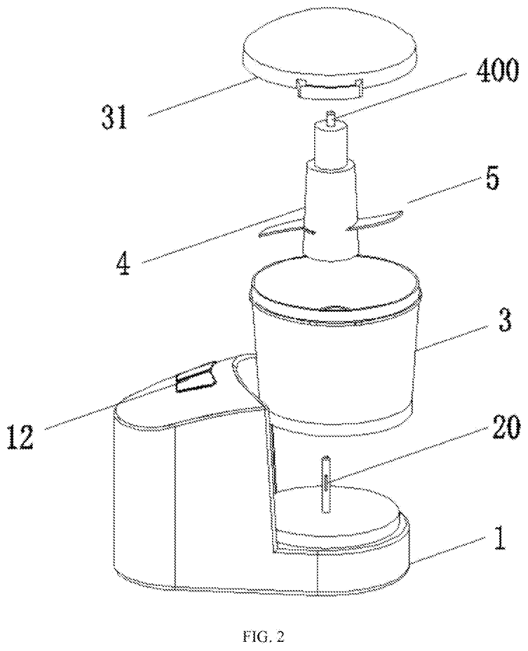

As shown in FIGS. 1-2, the present disclosure provides a dual-purpose food-processing appliance, comprising
a blending body 1, wherein the blending body 1 is provided with an assembly space 10 and a control unit 11;
a power unit 2, wherein the power unit 2 is assembled in the blending body 1, and a transmission shaft 20 on the power unit 2 penetrates into the assembly space 10;
a blending cup 3, wherein the blending cup 3 is mounted in the assembly space 10, and a hollow shaft tube 30 is disposed at an inner bottom of the blending cup 3; and
a replaceable blending unit 4, wherein the blending unit 4 is placed in the blending cup 3 and sleeved on the shaft tube 30, and the transmission shaft 20 passes through the shaft tube 30 to be connected with the blending unit 4.

The assembly space 10 can be a space formed on the blending body 1 or a space formed by a base extending outwards from the bottom of the blending body 1 and the blending body 1, both of which can be well adapted to the assembly of the blending cup 3 and the blending unit 4. The control unit 11 on the blending body 1 is used for controlling the start and stop of an action of the power unit 2 and can also adjust the speed to realize different blending requirements. By means of a series of transmissions, the power unit 2 can cooperate with the transmission shaft 20 passing upwards through the shaft tube 30 to be connected with the blending unit 4, so as to drive the blending unit 4 to act.

By driving the blending unit 4 to act through the power unit 2 in design, the food-processing appliance can realize not only meat mincing but also juicing functions such as juicing oranges, thereby being convenient to use and having improved practicality.

In this embodiment, the blending unit 4 comprises a meat mincing appliance 5 and a juicing appliance 6 interchangeable with the meat mincing appliance 5. The meat mincing appliance 5 is one set of unit capable of mincing meat, and the juicing appliance 6 is the other set of unit capable of juicing vegetables and fruits, thus realizing two replaceable blending units 4. Therefore, the food-processing appliance combines two functions.

In this embodiment, the meat mincing appliance 5 comprises a blending shaft 40 sleeved on the shaft tube 30 and at least 2 blending blades 41 distributed on the blending shaft 40. The blending shaft 40 is provided with an insertion shaft 400, and the transmission shaft 20 is inserted into the blending shaft 40. The blending shaft 40 is fixed by being sleeved on the shaft tube 30, and the transmission shaft 20 is inserted into the blending shaft 40 to facilitate the transmission shaft 20 driving the blending shall 40 to act. Two arc-shaped blending blades 41 are disposed on both side walls of the blending shaft 40 respectively to mince meat, vegetables, etc.

When the meat mincing appliance 5 in this embodiment is used as the blending unit 4, firstly a blending lid 31 is opened to disengage an upper end of the blending shaft 40 from the blending lid 31; then food materials are put into the blending cup 3; next the blending lid 31 is closed, and the corresponding blending shaft 40 is inserted into an insertion hole to be fixed and thereby stabilized; and finally the power unit 2 is controlled with a control button 12 to start blending to realize purposes of mincing meat, squeezing vegetables and fruits, etc.

### Embodiment

As shown in FIG. 2, a blending lid 31 is connected to the blending cup 3, and a fixing unit for insertion of the insertion shaft 400 is disposed on an inner wall of the blending lid 31; and the blending lid 31 is used to cover the blending cup 3 when the blending unit 4 is in use, thereby preventing debris from splashing out during the blending process. The fixing unit on the inner wall of the blending lid 31 facilitates fitting of the insertion shaft 400, thereby effectively avoiding significant shaking during rotation and improving the structural stability of the blending unit 4. The fixing unit is preferably an insertion hole into which the insertion shaft 400 is inserted for the purpose of enhancing the stability of the blending unit 4.

### Embodiment

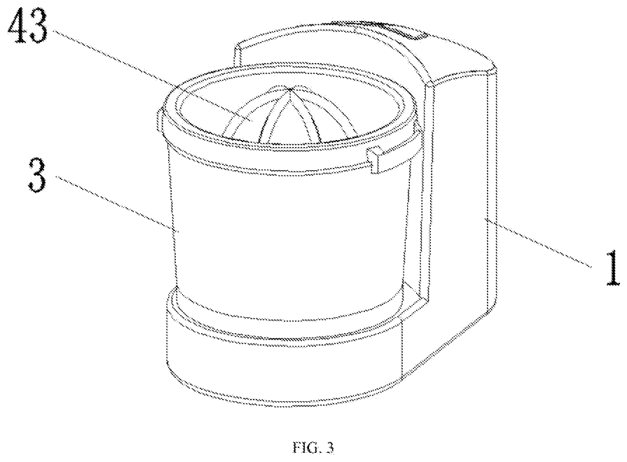

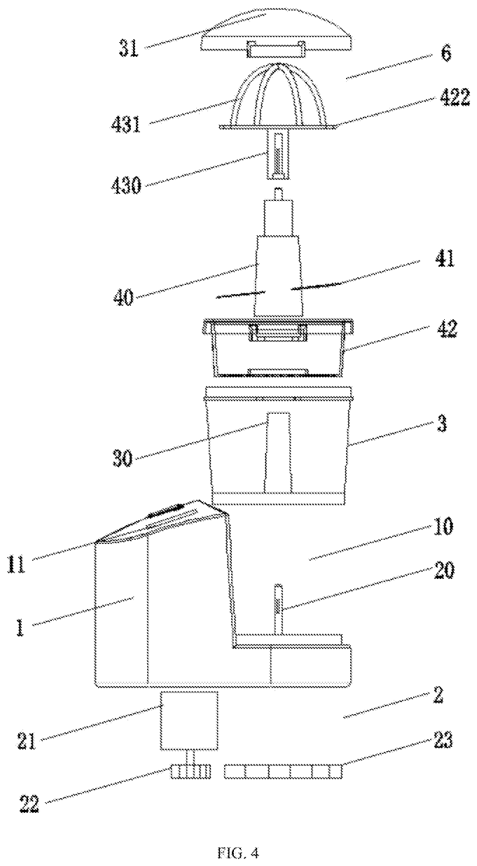

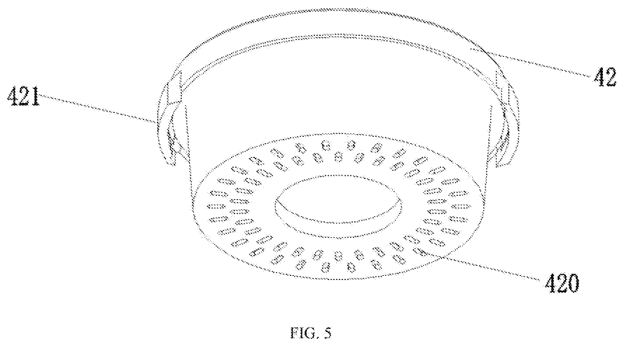

As shown in FIGS. 3-5, the juicing appliance 6 comprises a filtering portion 42 and a blender 43 connected in the filtering portion 42. A sleeve 430 connected with the transmission shaft 20 is connected to a bottom end of the blender 43, the sleeve 430 is inserted into the shaft tube 30, and a plurality of convex ribs 431 are disposed on the blender 43 in a staggered manner respectively. When the blender 43 rotates for juicing, juice can be effectively filtered through the filtering portion 42 and then enters the blending cup 3. The convex ribs 431 on the blender 43 can cut fruits such as oranges when the blender 43 rotates.

When the embodiment is use for juicing oranges for example, firstly the oranges are cut into halves and placed on the surface of the blender 43, and the oranges are pressed downward manually; then the power unit 2 is started to drive the blender 43 to rotate, the convex ribs 431 on the blender 43 continuously squeeze and cut orange pulp, and juice flows into the filter along the blender 43 and is filtered through filtering holes 420 on the filter, and finally the juice is collected into the blending cup 3.

In this embodiment, the blender 43 is disposed in a hemispherical structure, at least two supporting sheets 422 extend from an outer edge of the blender 43, and the supporting sheets 422 are pressed against an inner surface of the filtering portion 42. The support sheets 422 are limited on an inner surface of the filtering portion 42 and act along the inner surface of the filtering portion 42 when the blender 43 rotates to play a guiding role, thereby improving the reasonability of the blender's action.

In this embodiment, a plurality of filtering holes 420 are disposed at the bottom of the filtering portion 42. The filtering holes 420 at the bottom of the filtering portion 42 can effectively filter residues generated in the juicing process of the blender 43 and prevent the residues from flowing into the blending cup 3, thus effectively filtering the juice.

In this embodiment, the power unit 2 comprises a motor 21, a driving gear 22 connected with the motor 21, and a driven gear 23 fitting with the driving gear 22, wherein the driving gear 22 and the driven gear 23 are arranged side by side, and the driven gear 23 is connected with the transmission shaft 20. The transmission of the power unit 2 is achieved in a way that the motor 21 drives the driving gear 22 to rotate, and meanwhile the driven gear 23 is engaged to rotate synchronously, and finally the transmission shaft 20 is driven to rotate, thus realizing the action of the blending unit 4. Of course, other power transmission modes may be adopted to enable the transmission shaft 20 to rotate, so as to achieve the purpose of enabling the blending unit 4 to act.

In this embodiment, a limiting handle 421 is disposed on both sides of an upper edge of the filtering portion 42 respectively for facilitating grabbing. The limiting handle 421 not only facilitates the user to grab and clean the filtering portion but also can enhance the structural stability of the filtering portion 42.

In this embodiment, the blending body 1 is further provided with a control button 12 electrically connected with the control unit 11, and the control button 12 matches the control unit 11 to realize meat mincing and juicing functions of the food-processing appliance.

In the description of the specification, the description of the reference terms such as “one embodiment”, “some embodiments”, “examples”, “specific examples”, or “some examples” means that the specific features, structures, materials, or characteristics described in conjunction with the embodiment(s) or example(s) are included in at least one embodiment or example of the present disclosure. In this specification, the schematic representations of the above terms do not necessarily refer to the same embodiment or example. Moreover, the specific features, structures, materials, or characteristics described may be combined in any suitable manner in any one or more embodiments or examples. Furthermore, the various embodiments or examples and the features of the various embodiments or examples described in the specification can be combined by those skilled in the art without being contradictory.

The standard parts used in the present disclosure are available in the market, the special-shaped parts can be customized according to the description of the specification and the attached drawings, and the specific connection mode of each part is implemented by mature conventional means such as bolts, rivets, welding, sticking in the prior art, which will not be elaborated herein.

The above content only describes preferred embodiments of the present disclosure. Various modifications and changes can be made in the specific implementations and application scope by those of ordinary skill in the art according to the idea of the present disclosure. The content of the specification should not be understood as a limitation on the present disclosure, and any modifications, equivalent replacements, improvements, etc. made within the spirit and principle of the present disclosure should be included within the scope of the claims of the present disclosure.

What is claimed is:

1. A dual-purpose food-processing appliance, comprising
a blending body, wherein the blending body is provided with an assembly space and a control unit;
a power unit, wherein the power unit is assembled in the blending body, and a transmission shaft on the power unit penetrates into the assembly space;
a blending cup, wherein the blending cup is mounted in the assembly space, and a hollow shaft tube is disposed at an inner bottom of the blending cup; and
a replaceable blending unit, wherein the blending unit is placed in the blending cup and sleeved on the shaft tube, and the transmission shaft passes through the shaft tube to be connected with the blending unit.

2. The dual-purpose food-processing appliance according to claim 1, wherein the blending unit is a meat mincing appliance or a juicing appliance interchangeable with the meat mincing appliance.

3. The dual-purpose food-processing appliance according to claim 2, wherein the meat mincing appliance comprises a blending shaft sleeved on the shaft tube, and at least 2 blending blades distributed on the blending shaft, wherein the blending shaft is provided with an insertion shaft, and the transmission shaft is inserted into the blending shaft.

4. The dual-purpose food-processing appliance according to claim 2, wherein the juicing appliance comprises a filtering portion, and a blender connected in the filtering portion, wherein a sleeve connected with the transmission shaft is connected to a bottom end of the blender, the sleeve is inserted into the shaft tube, and a plurality of convex ribs are disposed on the blender in a staggered manner respectively.

5. The dual-purpose food-processing appliance according to claim 4, wherein the blender is disposed in a hemispherical structure, at least two supporting sheets extend from an outer edge of the blender, and the supporting sheets are pressed against an inner surface of the filtering portion.

6. The dual-purpose food-processing appliance according to claim 4, wherein a plurality of filtering holes are disposed at the bottom of the filtering portion respectively.

7. The dual-purpose food-processing appliance according to claim 1, wherein the power unit comprises a motor, a driving gear connected with the motor, and a driven gear fitting with the driving gear, wherein the driving gear and the driven gear are arranged side by side, and the driven gear is connected with the transmission shaft.

8. The dual-purpose food-processing appliance according to claim 4, wherein a limiting handle is disposed on both sides of an upper edge of the filtering portion respectively for facilitating grabbing.

9. The dual-purpose food-processing appliance according to claim 1, wherein the blending body is further provided with a control button electrically connected with the control unit.
